(19) United States
(12) Patent Application Publication
(10) Pub. No.: US 2015/0260029 A1
(43) Pub. Date: Sep. 17, 2015

(54) INTEGRATED PROCESS FOR ENHANCED OIL RECOVERY USING GAS TO LIQUID TECHNOLOGY

(71) Applicants: Rachid Mabrouk, Munich (DE); Harald Ranke, Pocking (DE)

(72) Inventors: Rachid Mabrouk, Munich (DE); Harald Ranke, Pocking (DE)

(21) Appl. No.: 14/637,437

(22) Filed: Mar. 4, 2015

Related U.S. Application Data
(60) Provisional application No. 61/950,918, filed on Mar. 11, 2014.

(51) Int. Cl. E21B 43/40; B01D 19/00; F25J 3/04; E21B 43/16

(52) U.S. Cl. CPC E21B 43/40; E21B 43/168; B01D 19/00; F25J 3/04569

(57) ABSTRACT

A system for enhanced oil recovery from an oil field that uses the associated gases collected to produce synthetic crude oil from a GTL plant. The pressure in the oil field is maintained by injecting nitrogen obtained from an ASU. The ASU is powered by an associated power plant that uses oxygen produced by the ASU and the Fisher Tropsch tail gases (hydrogen and steam) of the GTL plant. Nitrogen recovered from the tail gas of the power plant boosts the available nitrogen needed for the enhanced oil recovery operation.

### FIELD OF THE INVENTION

The invention relates to the use of associated gases separated during oil recovery from an oil field, for the production of synthetic crude oil.

### BACKGROUND OF THE INVENTION

During oil recovery from an oil field, crude oil is separated from associated gases, with the crude oil being sent on to a pipeline or the like. The associated gases can advantageously be re-injected into the oil field which helps to maintain the oil field pressure and also to enhance the of recovery by decreasing the oil viscosity. A generalized system layout for such an operation is shown in Prior Art FIG. 1. The material recovered from the oil field is separated into a crude oil stream that is sent to pipeline, and an associated gas stream that is re-injected to the oil field. However, not all of the gas can be re-injected and therefore excess gas may be flared which is a waste of a valuable resource.

To avoid flaring of the associated gas, processes have been developed that use the associated gas in the production of synthetic crude oil. This synthetic crude oil can be added to the crude oil recovered from the oil field and transported using the same pipeline. Prior Art FIG. 2 shows a generic system for such synthetic crude oil production. In particular, the associated gases are sent to a GTL (gas to liquid) plant which produces the synthetic crude oil as well as high pressure (HP) and low pressure (LP) steam. Because the associated gas is no longer being used for re-injection to the oil field, an Air Separation Unit (ASU) is associated with the system. The ASU separates nitrogen from the air, with the nitrogen being used for the enhanced oil recovery by injection into the oil field. In addition, the oxygen separated from the air by the ASU is used by the GTL for the production of the synthetic crude. This system has some disadvantages in that the ASU must have a power source. This power source requires the transport of fuel to the site of the ASU which can add significant operation costs and infrastructure.

There remains a need in the art for improvements to enhanced oil recovery systems as well as to the production of synthetic crude oil from the associated gases collected from an oil field.

### SUMMARY OF THE INVENTION

The invention provides a system that enhances oil recovery by producing synthetic oil from the associated gases. The system of the invention therefore provides the advantages of avoiding the need to flare associated gases and thus is more efficient. The system of the invention uses oxygen from the ASU and hydrogen from the GTL to produce the power necessary to run the ASU. This reduces the operation costs and complexity.

### BRIEF DESCRIPTION OF DRAWINGS

FIG. 1 is a schematic view of an enhanced oil recovery system according to the prior art.

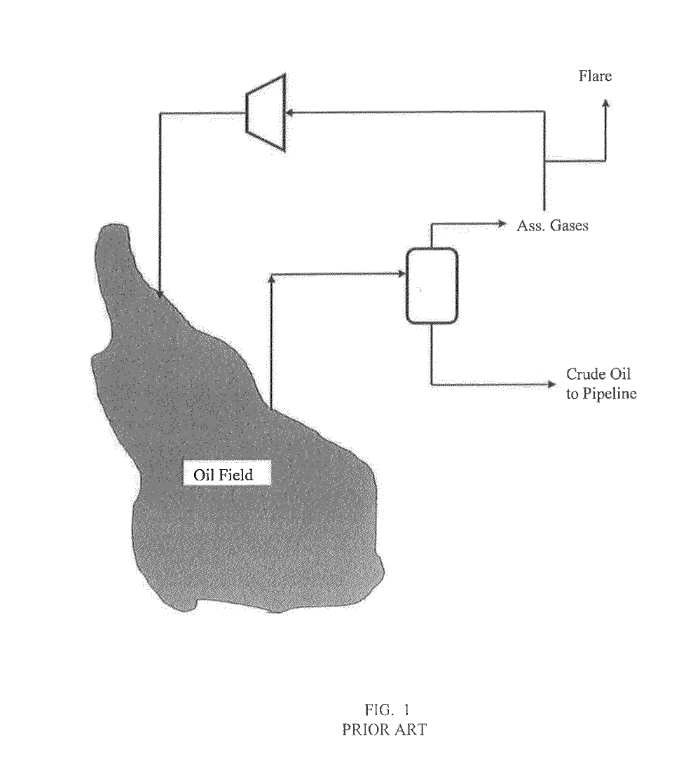

FIG. 2 is a schematic view of an enhanced oil recovery system with an incorporated ASU according to the prior art.

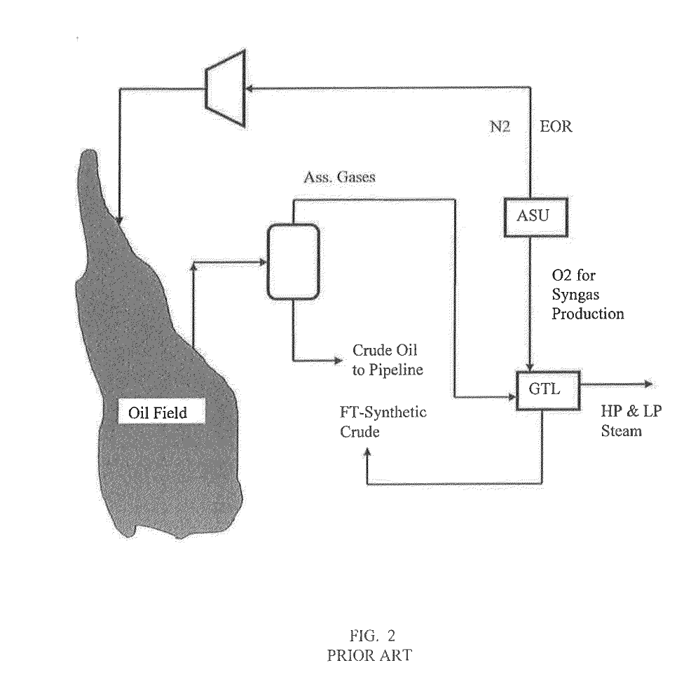

FIG. 3 is a schematic view of an enhanced oil recovery system according to the invention.

FIG. 4 is a schematic view of optional GTL plants that can be utilized in the invention,

### DETAILED DESCRIPTION OF PREFERRED EMBODIMENTS

The invention provides a system that enhances oil recovery from an oil field by using the associated gases collected to produce synthetic crude oil. The pressure in the oil field is maintained by injecting nitrogen obtained from an ASU. The ASU is powered from oxygen produced by the ASU and hydrogen obtained from the GTL plant used to produce the synthetic crude oil.

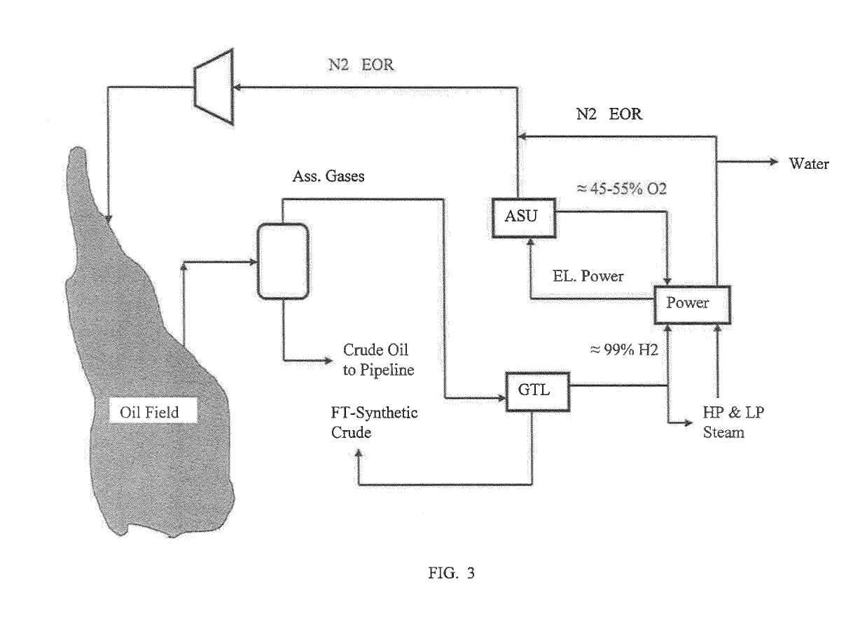

The invention will be described in greater detail with reference to FIG. 3. The crude oil collected from the oil field is sent from a transfer station to pipeline, while the associated gases from the oil field are sent to a GTL plant for processing to synthetic crude oil that is also sent to pipeline. The GTL also produces a hydrogen stream and HP/LP stream. Both of these byproducts are provided as fuel to a power generation plant. An ASU is associated with the system to produce nitrogen for injection to the oil field in the enhanced oil recovery operation. An oxygen stream (45-55% O2) obtained from the ASU is also provided as fuel to the power plant. The power plant utilizes the fuels provided thereto and produces electrical energy that is used to power the ASU. In addition, the flue gas from the power plant, which is comprised mainly of nitrogen and water, is cooled, and the water is condensed, leaving a nitrogen stream that can be added to the main nitrogen stream from the ASU and also used in the enhanced oil recovery operation.

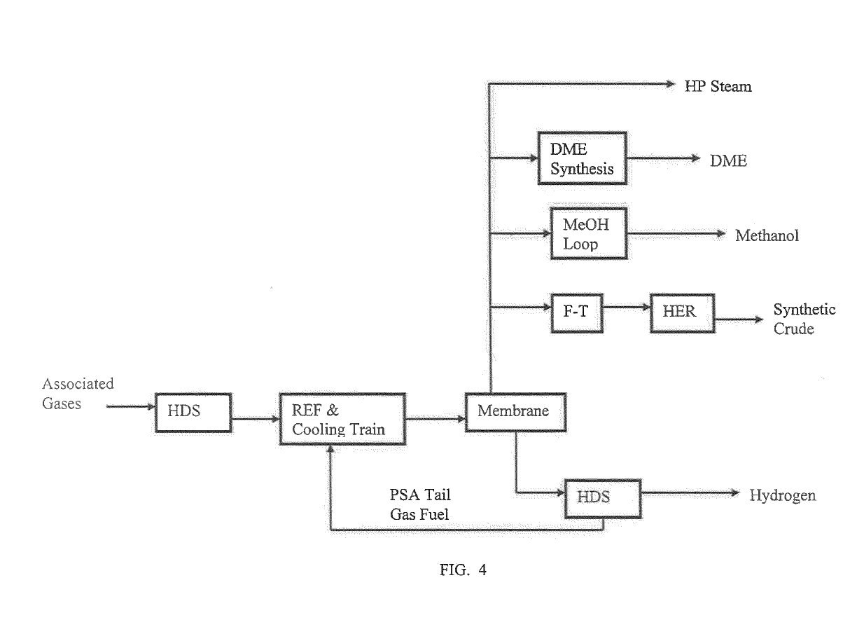

The above refers to a GTL plant for the production of synthetic crude oil. However, the invention is also applicable to other types of GTL plants. FIG. 4 is a schematic view of optional GTL plants that can be used in the invention. FIG. 4 shows the associated gases (AG) being delivered to the GTL plant that comprises three main sections. The first section is a hydro-desulphurization unit (HDS) and the second section is a reforming unit (REF) that may also include a cooling train. The associated gases are treated in these first two sections and then passed through a membrane with some of the gas being sent to a pressure swing absorption unit (PSA) for separation into a hydrogen stream and a tail gas stream that may be returned as fuel to the REF. HP steam is also produced by the REF. The rest of the associated gas is delivered to the third section of the GTL plant, for liquid hydrocarbon synthesis. FIG. 4, shows three different synthesis processes that can he carried out. In particular, synthetic crude can be produced by a Fischer Tropsch synthesis (F-T) with heat exchanger (HER) process. Alternatively, methanol can be produced from a methanol synthesis loop (MeOH Loop) or dimethyl ether can be produced by a dimethyl ether synthesis loop (DME Synthesis). It is also possible to include combinations of these alternative processes in the GTL plant.

The invention provides a number of advantages. The use of the associated gases to produce synthetic crude oil boosts the overall oil recovery and provides an efficient use of the associated gases. In particular, by using the associated gases to produce synthetic crude, the wasteful flaring of valuable material is avoided. In addition, by using the oxygen stream from the ASU and the Fischer Tropsch (hydrogen and steam) products of the GTL, to produce electrical power for the ASU, the overall efficiency of the system is improved and operational costs and complexity are reduced. Further, the flue gas from the power plant can be cooled and water condensed therefrom to recover more nitrogen and thereby boost the nitrogen available for the enhanced oil recovery operation.

The invention as discussed above has focused on the production of nitrogen by the ASU for enhanced oil recovery as well as separation of nitrogen from the flue gas of the power plant. However, the invention can also be used to produce CO₂. as well as different steam grades (HP and LP) that can also be used for enhanced oil recovery. Therefore, the system of the invention provides versatility and economic benefit.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is

1. A system for enhanced oil recovery comprising:
a separation unit for separating oil from an oil field into a crude oil stream and an associated gas stream wherein the crude oil stream is sent to a delivery pipeline;
a gas to liquid plant for receiving the associated gas stream and producing a synthetic crude oil stream, a hydrogen stream, high pressure steam and low pressure steam;
an air separation unit for producing a nitrogen stream that is injected into the oil field to enhance oil recovery, and an oxygen stream; and
a power plant that is fueled by the hydrogen steam, high pressure steam and low pressure steam from the gas to liquid plant and the oxygen stream from the air separation unit and produces power for powering the air separation unit, nitrogen that can he added to the nitrogen stream from the air separation unit and water.

2. The system according to claim 1 wherein the oxygen stream from the air separation unit is 45% to 55% oxygen.

3. The system according to claim 1 wherein the gas to liquid plant includes a hydro-desulphurization unit, a reforming unit, a membrane, a pressure swing absorption unit and at least one of a Fischer Tropsch synthesis with heat exchanger unit, a methanol synthesis loop, or a dimethyl ether synthesis loop.

4. The system according to claim 3 wherein the reforming unit includes a cooling train.

5. A method for enhancing oil recovery from an oil field, comprising:
separating oil recovered from the oil field into a crude oil stream and an associated gas stream;
delivering the crude oil stream to a delivery pipeline;
delivering the associated gas stream to a gas to liquid plant;
processing the associated gas stream in the gas to liquid plant into a synthetic crude oil stream, a hydrogen stream, high pressure steam and low pressure steam;
producing a nitrogen and oxygen in an air separation unit;
injecting nitrogen from the air separation unit into the oil field to enhance oil recovery;
delivering the hydrogen, high pressure steam and low pressure steam from the gas to liquid plant to a power plant;
delivering the oxygen stream from the air separation unit to the power plant;
producing power, nitrogen and water in the power plant;
delivering power from the power plant to the air separation unit to power the air separation unit; and
adding the nitrogen from the power plant to the nitrogen from the air separation unit.
